(19) United States
(12) Patent Application Publication
(10) Pub. No.: US 2025/0263047 A1
(43) Pub. Date: Aug. 21, 2025

(54) Window wiper device for a vehicle, comprising a main blade and a secondary blade

(71) Applicant: FORGES DE BELLES ONDES, SAINT JUNIEN (FR)

(72) Inventors: Pascal JEAN, Spay (FR); Damian TERRIS, SAINT JUNIEN (FR)

(21) Appl. No.: 18/856,869

(22) PCT Filed: Apr. 12, 2023
(86) PCT No.: PCT/FR2023/050526

§ 371 Date: Oct. 14, 2024

(30) Foreign Application Priority Data
Apr. 12, 2022 (FR) FR2203378

(51) Int. Cl. B60S 1/34; B60S 1/28; B60S 1/40; B60S 1/44

(52) U.S. Cl. CPC B60S 1/3429; B60S 1/28; B60S 1/4067; B60S 1/44

(57) ABSTRACT

A window wiper device (1, 20, 40, 100) having a pantographic arm (22) at the end of which a main wiper blade is attached. A secondary wiper blade (101), placed beneath the main wiper blade (32), is mounted on the pantographic arm (22) by means of a pantographic device that is intended to offset the secondary wiper blade (101) from the main wiper blade (32), such that the two wiper blades (32, 101) can perform their wiper functions continuously on the window (10).

### TECHNICAL FIELD

The present invention relates to a window wiper device for a vehicle, comprising a main blade and a secondary blade. It relates more particularly to vehicles provided with sizeable windows, such as railroad vehicles, for example. These windows may, for example, represent windshields of railroad locomotives and power cars.

In order to make it easier to understand the invention, the term “window wiper device” denotes a device that simultaneously sweeps over a window and evacuates water by means of at least one blade.

Public transport drivers have an important responsibility, namely conveying a large quantity of passengers to at least one given destination. It is therefore essential for these drivers to be able to see the surroundings of their vehicles clearly and precisely, otherwise they may make poor decisions at a given moment in terms of the driving to be adopted for said vehicles, and these decisions could lead to incidents or even accidents. In the case of a large window such as a windshield, for example, high-quality driver visibility is therefore required both in a large central region of said windshield, in order to follow the direction of movement of the vehicle, and in a peripheral region thereof, in order in particular to read signaling panels. As a result, the window wiper device of these vehicles must perform well both in terms of the wiping quality and in terms of the cleaning coverage provided on the window.

Currently, a first solution consists in using a single arm on which a large wiper blade is mounted, said arm being mounted so as to be pivotable about an axis placed in a central region of a lower wall bordering the bottom of the windshield. This type of angular wiping performs well in a central portion of the window, but remains ineffective at the various corners situated around this central portion. During this pivoting movement of the arm, the blade always remains aligned along the arm without moving relative thereto. If the wiper blade is mounted on the arm at an angle thereto, this angle remains constant during all the pivoting movements of the arm.

A second solution consists in using a pantograph-type arm. Schematically, such an arm has two parallel rods of the same length, each comprising a lower end mounted in rotation about a horizontal axis of a lower wall bordering the bottom of the windshield, and an upper end to which a support part is fastened. More precisely, the support part connects the two upper ends of the two rods while being mounted in an articulated manner on each of said upper ends, said support part bearing a single elongate wiper blade. This wiper blade is fixedly secured to the support part. When this type of window wiper device is actuated, the two rods pivot simultaneously about their lower ends, and the wiper blade slides over the window describing a curve while always maintaining the same orientation in space, whatever the position of the two rods. It should be noted that the two rods of the arm remain parallel during the whole of the pivoting movement of said arm. A window wiper comprising a pantograph-type arm promotes the cleaning of the lateral portions of the window, but cannot provide cleaning of a central lower region of said window.

A third solution consists in combining a pantograph-type arm bearing a large main wiper blade, and a smaller secondary wiper blade fixedly secured to one of the two rods of the pantograph-type arm. This secondary wiper blade is intended to clean the windshield in a central lower region thereof. A risk associated with such an arrangement is that the main wiper blade and the secondary wiper blade might collide with one another when the pantograph-type arm is in the course of pivoting. However, such a collision cannot take place since it would risk leading to jamming of the window wiper device and possibly to damage to this device. In order to prevent this collision, the positioning of the secondary wiper is lowered on the rod that supports it. However, while such a configuration would prevent a collision between the two wiper blades, it would leave a region of the window, namely the region lying between an upper end of the secondary blade and a lower end of the main wiper blade, that remains completely uncleaned. Such a situation is not ideal for driver visibility.

It will be recognized that the various window wiper solutions currently proposed are not satisfactory for providing complete cleaning of a large window, such as a windshield of a railroad or subway locomotive or power car, for example.

A window wiper device according to the invention is designed in such a way that it can efficiently clean the whole of a large window, whether in a large central region thereof, or at the periphery of this central region, or in a central lower region of said window.

One subject of the invention is a window wiper device comprising a pantograph-type arm comprising two parallel rods of the same length, each of the two rods comprising a first lower end mounted in rotation about a horizontal axis of rotation intended to be fastened to a lower wall bordering the bottom of a window to be cleaned, said two first ends being aligned along a horizontal axis, said two rods comprising second upper ends aligned along a horizontal axis and connected to one another by a support part mounted in an articulated manner on said second ends, said support part bearing a main wiper blade mounted fixedly on said support part.

According to the invention, the window wiper device comprises:
a first connecting part comprising a first segment connecting the two rods by means of two first pivot connections, and a second inclined segment extending said first segment,
a second connecting part comprising a segment connecting the two rods by means of two second pivot connections, said segment comprising a projecting pin,
a secondary wiper blade placed below the main wiper blade and mounted in an articulated manner on the second segment of the first connecting part, said secondary wiper blade comprising a groove in which the projecting pin of the segment of the second connecting part is placed, said pin being able to slide in said groove to allow the secondary wiper blade to rotate when the two rods pivot.

When the window wiper device is actuated, it causes a rotational movement consisting of multiple reciprocating motions of the pantograph-type arm so that the main wiper blade, which is fixed in a given position on said arm, can clean a large central region of the window. During this rotational movement of the two rods, consisting of multiple reciprocating motions, the secondary wiper blade also pivots below the main wiper blade while being offset therefrom so as to clean a central lower region of the window. The principle of a window wiper device according to the invention is to employ a main wiper blade and a secondary wiper blade placed below said main wiper blade, without said two blades being able to collide with one another during the back-and-forth rotational movement of the pantograph-type arm, and while allowing said two blades to cover a large and continuous cleaning region of the window. The objective of the two different connecting parts used for fastening the secondary wiper blade to the rods of the pantograph-type arm is to cause said secondary wiper blade to pivot relative to these two rods and avoid a collision with the main wiper blade. In this way, when the pantograph-type arm is placed on one side of the window, the secondary arm emerges below the two rods of the pantograph-type arm. When the pantograph-type arm pivots toward a vertical central position of the window, the secondary wiper blade has also pivoted in the same direction, folding progressively along the two rods of the pantograph-type arm so as to be likewise in a vertical position. Finally, when the pantograph-type arm tilts on the other side, the wiper blade pivots in the same direction as the pantograph-type arm but ahead of it. The orientation of the main wiper blade on the pantograph-type arm remains constant during the rotational movement consisting of multiple reciprocating motions of said arm. Advantageously, the main wiper blade extends vertically during this rotational movement. Preferably, the first segment and the second segment of the first connecting part, and also the segment of the second connecting part, are assumed to be rectilinear. Advantageously, the projecting pin is placed in the center of the segment. To summarize the principle of the invention, the main wiper arm is mounted on a pantograph-type arm, and the secondary wiper blade is mounted on said pantograph-type arm by means of a pantograph-type device.

According to one possible feature of the invention, the secondary wiper blade is rectilinear and the main wiper blade is rectilinear, the length of said secondary wiper blade being less than that of said main wiper blade. The secondary wiper blade supplements the main wiper blade to provide continuous cleaning over virtually the whole of the surface of the window, the term “continuous” meaning “without leaving regions which would not be cleaned either by the main wiper blade or by the secondary wiper blade”.

According to one possible feature of the invention, the groove extends along a longitudinal axis of the secondary wiper blade over at least part of the total length of said secondary wiper blade. Preferably, the groove extends over less than half of the total length of the secondary wiper blade.

According to one possible feature of the invention, the two first pivot connections of the first segment of the first connecting part for connection to the two rods are each placed at a constant distance from the first end of each of the two rods. This means that the first segment of the first connecting part always extends horizontally, whatever the degree of inclination of the two rods of the pantograph-type arm.

According to one possible feature of the invention, the two second pivot connections of the segment of the second connecting part for connection to the two rods are each placed at a constant distance from the first end of each of the two rods. This means that the segment of the second connecting part always extends horizontally, whatever the degree of inclination of the two rods of the pantograph-type arm.

According to one possible feature of the invention, the distance separating the two second pivot connections and the first ends of the two rods is less than the distance separating the two first pivot connections and said first ends of the two rods. This configuration suggests that the second connecting part is situated below the first connecting part.

According to one possible feature of the invention, the second segment of the first connecting part is perpendicular to the first segment of said first connecting part. The second segment extends the first segment in a fixed manner, that is to say without the possibility of movement with respect to said first segment.

According to one possible feature of the invention, the second segment of the first connecting part extends vertically. This means that the second segment of the first part extends vertically, whatever the degree of inclination of the two rods of the pantograph-type arm.

According to one possible feature of the invention, the secondary wiper blade is mounted in an articulated manner at one end of the second segment of the first connecting part.

According to one possible feature of the invention, the main wiper blade is mounted fixedly on the support part so as to extend vertically. For such a position of the main wiper blade, the surface area of the window that will be cleaned by said main wiper during the rotational movement involving multiple reciprocating motions will be as large as possible.

Another subject of the invention is an assembly comprising the front of a vehicle having a window and a lower wall bordering the bottom of said window.

According to the invention, this assembly comprises a window wiper device comprising a pantograph-type arm comprising two parallel rods of the same length, each of the two rods comprising a first lower end mounted in rotation about a horizontal axis of rotation fastened to the lower wall, said two first ends being aligned along a horizontal axis, said two rods comprising second upper ends aligned along a horizontal axis and connected to one another by a support part mounted in an articulated manner on said second ends, said support part bearing a main wiper blade mounted fixedly on said support part, said device comprising:
a first connecting part comprising a first segment connecting the two rods by means of two first pivot connections, and a second inclined segment extending said first segment,
a second connecting part comprising a segment connecting the two rods by means of two second pivot connections, said segment comprising a projecting pin,
a secondary wiper blade placed below the main wiper blade and mounted in an articulated manner on the second segment of the first connecting part, said secondary wiper blade comprising a groove in which the projecting pin of the segment of the second connecting part is placed, said pin being able to slide in said groove to allow the secondary wiper blade to rotate when the two rods pivot.

A window wiper device according to the invention has the advantage of allowing complete cleaning of a sizeable window by virtue of judicious mounting of a secondary wiper blade placed with a variable offset from a pantograph-type arm supporting a main wiper blade. Specifically, the secondary wiper blade is mounted on the pantograph-type arm by means of a pantograph-type device, and can therefore be offset automatically from said arm depending on the angle of inclination of this arm.

A detailed description is given below of a preferred embodiment of a window wiper according to the invention with reference to the following figures:

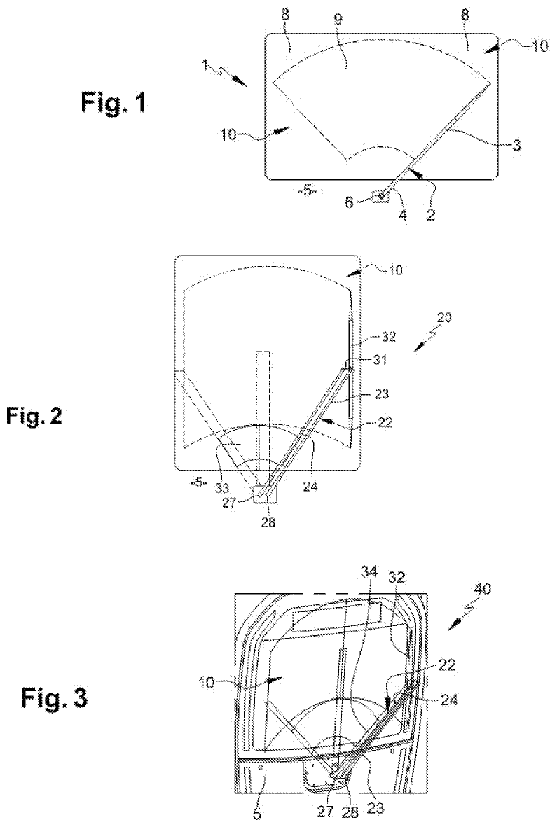

FIG. 1 is a front view of the front of a vehicle and of a first embodiment of a window wiper device according to the prior art,

FIG. 2 is a front view of the front of a vehicle and of a second embodiment of a window wiper device according to the prior art,

FIG. 3 is a front view of the front of a vehicle and of a third embodiment of a window wiper device according to the prior art,

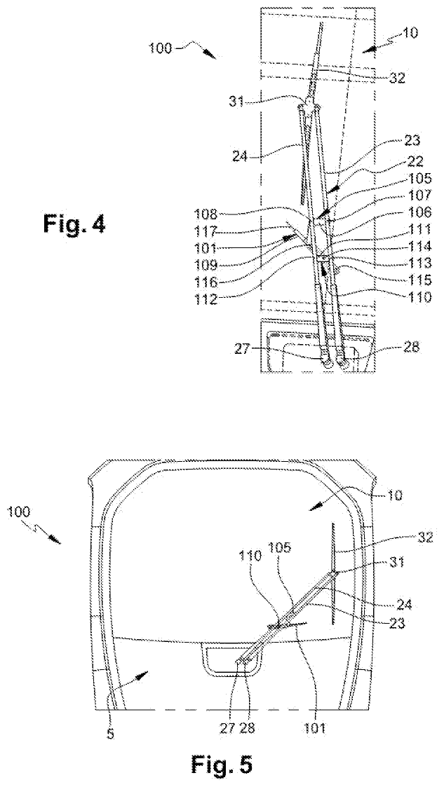

FIG. 4 is a front view of a region of the front of a vehicle and of a window wiper device according to the invention,

FIG. 5 is a front view of the front of a vehicle and of the window wiper device according to the invention, in a first operating phase,

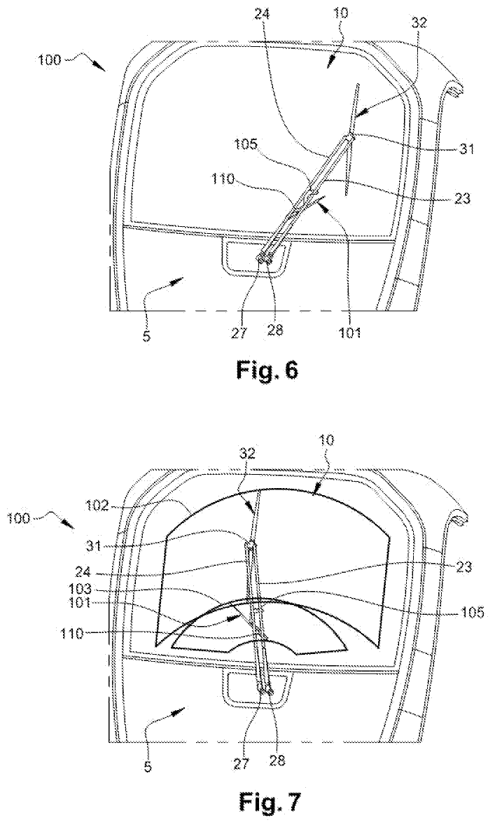

FIG. 6 is a front view of the front of a vehicle and of the window wiper device according to the invention, in a second operating phase,

FIG. 7 is a front view of the front of a vehicle and of the window wiper device according to the invention, in a third operating phase,

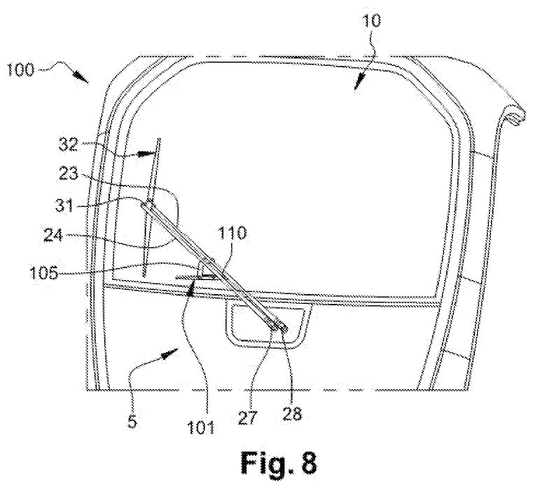

FIG. 8 is a front view of the front of a vehicle and of the window wiper device according to the invention, in a fourth operating phase.

The detailed description which follows, concerning the existing embodiments and the embodiment according to the invention, is given with consideration to a front end of a railroad or subway locomotive or power car, said front end comprising a large window and a lower wall. It is assumed that the lower wall borders the bottom of the window and extends in the same plane as that of said window, said plane being substantially vertical. In a general manner, the window wiper device will sweep over an outer surface of the window in order to dislodge solid or liquid particles deposited on this window, and, in the case of liquid particles, will also serve to evacuate them from said window.

With reference to FIG. 1, a first embodiment 1 of a window wiper device according to the prior art comprises a rectilinear arm 2 provided with a wiper blade 3 extending at least partially along said arm. This arm 2 has a lower end 4, which is mounted in rotation about a horizontal axis of rotation 6 fastened to the lower wall 5 and extending perpendicularly to said lower wall 5, and a free upper end 7. In the embodiment illustrated in FIG. 1, the axis of rotation 6 is placed in a central region of the lower wall 5. When the window wiper device 1 is activated, the arm 2 simply pivots about the axis of rotation 6 with a predefined angular amplitude. It will be recognized that, with such a window wiper device 1, the corners 8 placed around a large central region 9 of the window 10 are not reached by the wiper blade 3 and can therefore not be cleaned.

With reference to FIG. 2, a second embodiment 20 of a window wiper device according to the prior art comprises a pantograph-type arm 22 comprising two parallel rods 23, 24 of the same length. Each of said rods 23, 24 has a lower end mounted in rotation about a horizontal axis of rotation 27, 28 fastened to the lower wall 5 and extending perpendicularly to said lower wall 5. These two axes of rotation 27, 28 are parallel and are aligned along a horizontal axis. Each of said rods 23, 24 has an upper end, said two upper ends being connected to one another by a support part 31 mounted in an articulated manner thereon. This support part 31 is dimensioned in such a way that the spacing between the two upper ends is equal to the spacing between the two lower ends. An elongate and rectilinear wiper blade 32 is mounted fixedly on the support part 31 and extends along a vertical axis. In the embodiment illustrated in FIG. 2, the two axes of rotation 27, 28 are placed in a central region of the lower wall 5. When the window wiper device 20 is activated, the two rods 23, 24 of the arm 22 pivot simultaneously about the two axes of rotation 27, 28 with a predefined angular amplitude. During this pivoting movement, the two rods 23, 24 pivot while always remaining parallel, and the wiper blade 32 also pivots while describing a curved region, remaining vertical all the while. It will be recognized that, with such a window wiper device 20, the region of the window 10 that is cleaned by the wiper blade 32 is larger than the region that is swept with the first embodiment described above. On the other hand, with reference to FIG. 2, a central lower region 33 of the window 10 is not cleaned by the second embodiment 20 of a window wiper device according to the prior art.

With reference to FIG. 3, in order to clean this central lower region 33 of the window 10, a third embodiment 40 of a window wiper device according to the prior art consists in adopting the second embodiment 20 of a window wiper device described above and of adding to it a secondary wiper blade 34 that is shorter than the main wiper blade 32 mounted on the support part 31 connecting the two rods 23, 24 of the pantograph-type arm 22. This secondary wiper blade 34 is fastened to one of the two rods 23, 24 of the pantograph-type arm 22 and extends along the rod 23, 24 on which it is fastened. This secondary wiper blade 34 has no possibility of movement with respect to the rod 23, 24 on which it is mounted, and will therefore pivot simultaneously with said rod 23, 24. However, fastening such a secondary wiper blade 34 on one of the two rods 23, 24 of the pantograph-type arm 22 is not ideal for cleaning a central lower region 33 of the window, the reason being that
either it is positioned too low on the rod 23, 24 so as to avoid a collision with the main wiper blade 32 fastened to the end of the arm 22, and in this case there will remain a region of the window 10 that is not cleaned either by the main wiper blade 32 or by the secondary wiper blade 34, said region being situated between the two regions that will be cleaned by the two wiper blades 32, 34,
or it is positioned too high on the rod 23, 24 and will then not be able to avoid a collision with the main wiper blade 32 fastened to the end of the pantograph-type arm 22.

It is indeed not ideal to consider that the secondary wiper blade 34 becomes tangential to the other wiper blade 32 while ensuring a resultant cleaning region on the window 10 that is perfectly continuous.

With reference to FIGS. 4, 5, 6, 7 and 8, in order to provide as complete as possible cleaning of a large window 10, a window wiper device 100 according to the invention involves a main wiper blade 32 and a secondary wiper blade 101. The main wiper blade 32 is intended to clean a large main region 102 of the window 10, whereas the secondary wiper blade 101 is intended to clean a lower central region 103 of said window 10. The window wiper device 100 according to the invention is distinguished from the third embodiment 40 of an above-described window wiper device according to the prior art only in terms of the mounting of the secondary wiper blade 101. Therefore, since the mounting of the main wiper blade 32 on a pantograph-type arm 22 is in all points identical to that of the main wiper blade 32 of said third embodiment, it will not be described again. Only the mounting of the secondary wiper blade 101 is described in detail here.

With reference to FIGS. 4, 5, 6, 7 and 8, a window wiper device 100 according to the invention comprises:
a first connecting part 105 comprising a first segment 106 connecting the two rods 23, 24 of the pantograph-type arm 22 by means of two first pivot connections 107, 108, and a second inclined segment 109 extending said first segment 106. The second segment 109 is perpendicular to the first segment, and the two first pivot connections 107, 108 are placed at a constant distance from the lower ends of the two rods 23, 24. In this way, the first segment 106 extends horizontally and the second segment 109 extends vertically, whatever the angle of inclination of said two rods 23, 24,
a second connecting part 110 comprising a segment 111 connecting the two rods 23, 24 by means of two second pivot connections 112, 113, said segment 111 comprising a projecting pin 114. The two second pivot connections 112, 113 are placed at a constant distance from the lower ends of the two rods 23, 24, with the result that the segment 111 always extends horizontally, whatever the angle of inclination of the two rods 23, 24. The second connecting part 110 is placed below the first connecting part 105.

The secondary wiper blade 101 is placed below the main wiper blade 32 and comprises a groove 115 extending along a longitudinal axis of the secondary wiper blade 101. Preferably, the groove 115 extends over a distance that is less than half the length of said secondary wiper blade 101. The secondary wiper blade 101 is mounted in an articulated manner at a free end 116 of the second segment 109 of the first connecting part 105, such that the projecting pin 114 of the segment 111 of the second connecting part 110 enters the groove 115 in the secondary wiper blade 101 and is able to slide in said groove to allow the secondary wiper arm 101 to rotate. The fastening point of the secondary wiper blade 101 at the free end of the second segment 109 of the first connecting part 105 is situated in a central region of said secondary wiper blade 101. This fastening point thus separates the groove 115 and a solid portion 117 of said secondary wiper blade 101.

With reference to FIG. 5, by virtue of such an arrangement of the two wiper blades 32, 101, the window wiper device 100 will be in a first end configuration in which the two rods 23, 24 of the pantograph-type arm 22 will be fully inclined on one side of the window 10. For this first configuration, the main wiper blade 32, which extends vertically, is situated in a lateral end region of the window 10, whereas the secondary wiper blade 101 extends horizontally toward said lateral end region while emerging below said two rods 23, 24.

With reference to FIG. 6, when the window wiper device 100 is driven from the preceding first configuration, the two rods 23, 24 pivot about their lower ends so as to approach a central region of the window 10 away from the lateral end region of said window 10. The main wiper blade 32 remains in a vertical position, whereas the secondary wiper blade 101 pivots in the same direction as the two rods 23, 24, approaching them. In other words, the secondary wiper blade 101 pivots in the same direction as the two rods 23, 24, but more quickly than them.

With reference to FIG. 7, the pantograph-type arm 22 continues to pivot in the same direction, passing beyond a central vertical axis of the window 10. It is thus on the other side of the window 10 with respect to the first configuration. The main wiper blade 32 therefore continues to pivot while remaining vertical, and the secondary wiper blade 101 also pivots in the same direction, being more inclined than the two rods 23, 24 of the pantograph-type arm 22. In other words, the secondary wiper blade 101 has pivoted on the other side of the two rods 23, 24 of the pantograph-type arm 22.

With reference to FIG. 8, the main wiper blade 32 and the secondary wiper blade 101 complete their rotational travel so as to be in a configuration which is symmetrical with respect to the first configuration illustrated in FIG. 6.

This extreme-amplitude wiping illustrated in FIGS. 5, 6, 7 and 8 may be repeated multiple times depending on the particular requirements, for example when there is rain and the above-ground train or subway train is traveling in the open. The window wiper device 100 thus performs multiple extreme-amplitude reciprocating motions over a given period.

To sum up, a window wiper device 100 according to the invention makes it possible to fully exploit the cleaning action of a main wiper blade 32 and the cleaning action of a secondary wiper blade 101 so as to allow complete cleaning of a large window 10. For this purpose, the secondary wiper blade 101 is mounted on the pantograph-type arm 22 bearing the main wiper blade 32, by means of a device which is itself of pantograph type. By virtue of this ingenious mounting of the secondary wiper arm 101 on the pantograph-type arm 22 bearing the main wiper blade 32, the two blades 32, 101 clean the window 10 while being offset with respect to one another, without the risk of colliding with one another and without leaving a region of the window 10 that would not be covered by said two wiper blades 32, 101.

In a variant embodiment of a window wiper device 100 according to the invention:
the main wiper blade 32 may be mounted so as to be offset with respect to a vertical direction,
the ratio of the length of the main wiper blade 32 to the length of the secondary wiper blade 101 may be adjusted depending on the particular requirements,
the two axes of rotation 27, 28 of the two rods 23, 24 of the pantograph-type arm 22 may be placed in a region of the lower wall 5 that is offset laterally with respect to a central region,
the length of the second segment 109 of the first connecting part 105 may vary to adapt the starting angle of the secondary blade 101,
a spring may be integrated between the secondary blade 101 and the second segment 109 of the first connecting part 105 at the free end 116 of said second segment 109. This spring makes it possible to ensure that the secondary blade 101 presses on the window 10 without lifting the arm and therefore the main wiper blade 32.

1. A window wiper device comprising:
a pantograph-type arm comprising two parellel rods of the same length, each of the two rods comprising a first lower end mounted in rotation about a horizontal axis of rotation intended to be fastened to a lower wall bordering the bottom of a window to be cleaned, said two first ends being aligned along a horizontal axis, said two rods comprising second upper ends aligned along a horizontal axis and connected to one another by a support part mounted in an articulated manner on said second ends, said support part bearing a main wiper blade mounted fixedly on said support part,
said window wiper device comprises:
a first connecting part comprising a first segment connecting the two rods by means of two first pivot connections, and a second inclined segment extending said first segment,
a second connecting part comprising a segment connecting the two rods by means of two second pivot connections, said segment comprising a projecting pin,
a secondary wiper blade placed below the main wiper blade and mounted in an articulated manner on the second segment of the first connecting part, said secondary wiper blade comprising a groove in which the projecting pin of the segment of the second connecting part is placed, said pin being able to slide in said groove to allow the secondary wiper blade to rotate when the two rods pivot.

2. The window wiper device as claimed in claim 1, wherein the secondary wiper blade is rectilinear and the main wiper blade is rectilinear, and in that the length of said secondary wiper blade is less than that of said main wiper blade.

3. The window wiper device as claimed in claim 2, wherein the groove extends along a longitudinal axis of the secondary wiper blade over at least part of the total length of said secondary wiper blade.

4. The window wiper device as claimed in claim 1, wherein the two first pivot connections of the first segment of the first connecting part for connection to the two rods are each placed at a constant distance from the first end of each of the two rods.

5. The window wiper device as claimed in claim 1, wherein the two second pivot connections of the segment of the second connecting part for connection to the two rods are each placed at a constant distance from the first end of each of the two rods.

6. The window wiper device as claimed in claim 5, wherein the distance separating the two second pivot connections and the first ends of the two rods is less than the distance separating the two first pivot connections and said first ends of the two rods.

7. The window wiper device as claimed in claim 1, wherein the second segment of the first connecting part is perpendicular to the first segment of said first connecting part.

8. The window wiper device as claimed in claim 4, wherein the second segment of the first connecting part extends vertically.

9. The window wiper device as claimed in claim 4, wherein the secondary wiper blade is mounted in an articulated manner at one end of the second segment of the first connecting part.

10. The window wiper device as claimed in claim 1, wherein the main wiper blade is mounted fixedly on the support part so as to extend vertically.

11. An assembly comprising:
the front of a vehicle having a window and a lower wall bordering the bottom of said window,
wherein said assembly comprises a window wiper device comprising a pantograph-type arm comprising two parallel rods of the same length, each of the two rods comprising a first lower end mounted in rotation about a horizontal axis of rotation fastened to the lower wall, said two first ends being aligned along a horizontal axis, said two rods comprising second upper ends aligned along a horizontal axis and connected to one another by a support part mounted in an articulated manner on said second ends, said support part bearing a main wiper blade mounted fixedly on said support part, said device comprising:
a first connecting part comprising a first segment connecting the two rods by means of two first pivot connections, and a second inclined segment extending said first segment,
a second connecting part comprising a segment connecting the two rods by means of two second pivot connections, said segment comprising a projecting pin,
a secondary wiper blade placed below the main wiper blade and mounted in an articulated manner on the second segment of the first connecting part, said secondary wiper blade comprising a groove in which the projecting pin of the segment of the second connecting part is placed, said pin being able to slide in said groove to allow the secondary wiper blade to rotate when the two rods pivot.
